(19) United States
(12) Patent Application Publication
(10) Pub. No.: US 2006/0151615 A1
(43) Pub. Date: Jul. 13, 2006

(54) Radio identifiable mark

(75) Inventor: Yin Wen Cheng, Hsin-Chuang City (TW)

Correspondence Address: TROXELL LAW OFFICE PLLC;SUITE 1404, 5205 LEESBURG PIKE, FALLS CHURCH, VA, 22041, US

(73) Assignee: Taiwan Name Plate Co., Ltd.

(21) Appl. No.: 11/033,374

(22) Filed: Jan. 12, 2005

(51) Int. Cl. G06K 19/06; G06K 7/08

(52) U.S. Cl. 235/492; 235/451

(57) ABSTRACT

A radio identifiable mark planted with induction coil and chip module electrically connected to each other; ID program or code being burnt in the chip module; the coil supplying RF signals and energy between the mark and a reader for data exchange; the mark being mounted to an object and entering into the working area of a transmission antenna of a reader of RFID in a sales outlet; the chip module then generating inducted current thus to activate the chip module for transmitting through a built-in antenna the information of the code the mark for a host to judge its legitimacy and issue command to execute proper response.

### BACKGROUND OF THE INVENTION

(a) Field of the Invention

The present invention is related to a radio identifiable mark, and more particularly to one planted with a chip to transmit burn-in programs for a radio frequency identification system, RFID to identify for distribution control and counterfeit prevention.

(b) Description of the Prior Art

Whereas a conventional mark describes or represents a certain object in a unique and specific design to simply indicate the existence of the object, it contains the general presentation of the purpose, content, and nature of the object.

The application of bar code of the prior art involves the attachment a bar code to a commodity for ID purpose. A bar code reader transmits an induction signal to the bar code. The inducted signal is compared in a pre-stored database in the memory of the bar code reader to search for the particulars of the inducted signal to avail the basic data of the commodity for tracing the distribution carrier, e.g., description, inventory control, admission to warehouse, assortment and distribution routes. However, upon scanning the bar code, it reads only a single lot of data, and the scanner must be placed in the very front of the object where the bar code is located without permitting any barrier in between. The reading rate is comparatively slower and the data reading is only possible within a very short range between the scanner and the bar code to add more difficulties in the distribution control. Furthermore, the bar code fails to prevent the counterfeit since it cannot identify one.

### SUMMARY OF THE INVENTION

The primary purpose of the present invention is to provide a radio identifiable mark to correct the flaws found with the prior art. To achieve the purpose, the mark contains an induction coil and a chip module electrically connected to each other. The chip module is burnt in an identification program (or a code). The mark is attached to an object (a commodity sold in a supermarket or similar place). An antenna built in a reader of a radio frequency identification system (RFID) constantly transmits signal (e.g., RF, Micro or IR signal) and the mark is made entering into the range of the work area of the transmission antenna of the reader for the induction coil built in the mark to be inducted to generate current to activate the chip module in the mark. The program (or the code) burnt in the chip module communicates with the reader through the induction coil in the mark and transmits the program (code) back to the rear end host in the RFID for the host to judge the basic data of the object from the program or the code (e.g., ID, price, quantity, expiry date, verification . . . etc.). Accordingly, through the program of the basic data of the object installed in the chip module, more detailed data of the object are installed in the chip module to facilitate distribution control, warehousing control and counterfeit prevention purposes.

### BRIEF DESCRIPTION OF THE DRAWINGS

FIG. 1 is a perspective view of a mark of a first preferred embodiment of the present invention.

FIG. 2 is a schematic view showing the mark of the first preferred embodiment of the present invention is in use.

FIG. 3 is a block chart of the radio ID system and the mark of the first preferred embodiment of the present invention.

FIG. 4 is a perspective view of a second preferred embodiment of the present invention.

FIG. 5 is a schematic view showing the mark of the second preferred embodiment of the present invention in use.

### DETAILED DESCRIPTION OF THE PREFERRED EMBODIMENTS

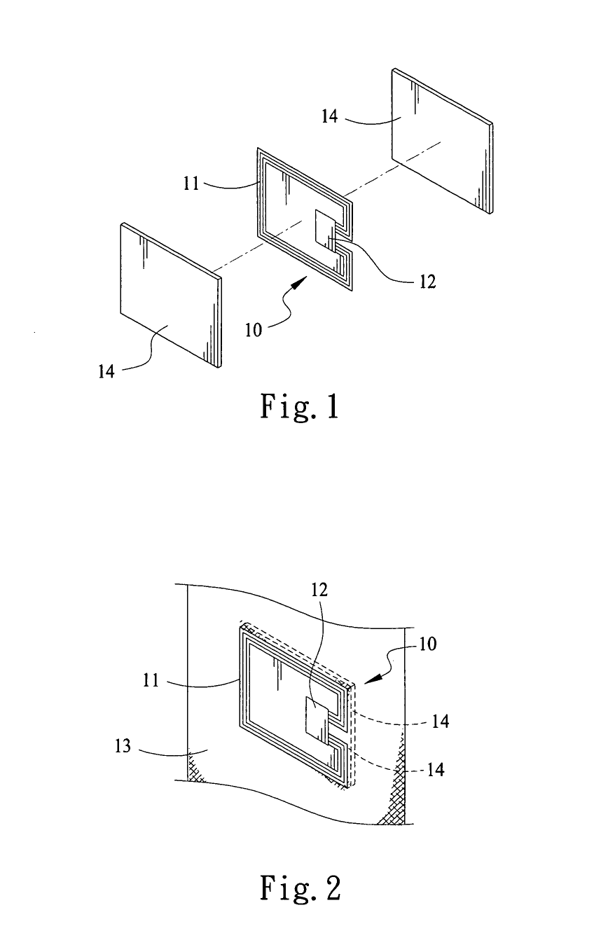

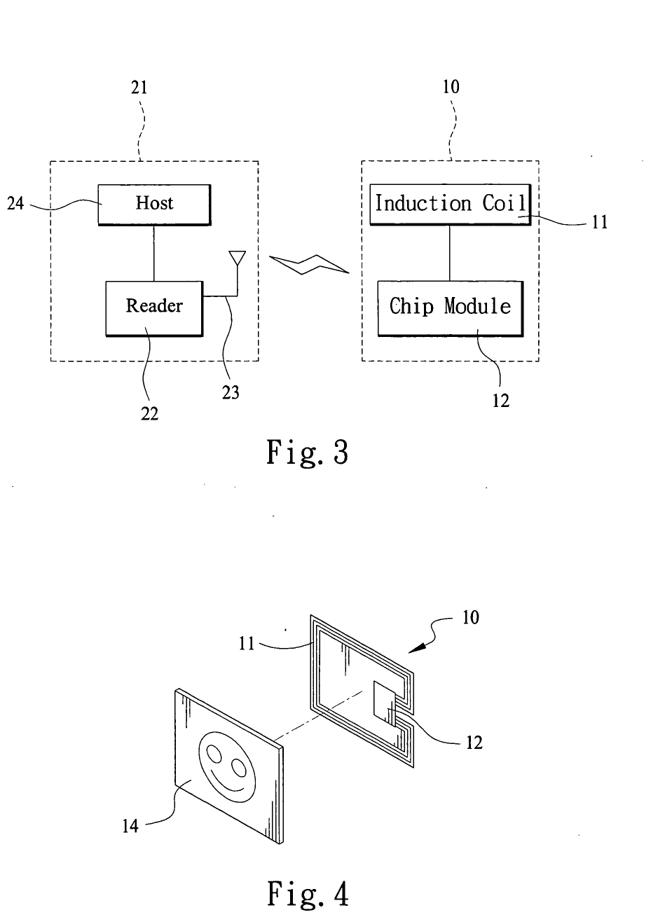

The present invention relates to a radio identifiable mark. As illustrated in FIGS. 1 and 2, a first preferred embodiment of the present invention includes a body 10 containing an induction coil 11 and a chip module 12. Both of the induction coil 11 and the chip module 12 are electrically connected to each other. The chip module 12 is burnt in a program or a code for identification. The body 10 is attached to an object 13. As illustrated in FIG. 3, a reader 22 of a radio frequency identification (RFID) system 22 constantly transmits radio signal (e.g., RF, IR, or microwave signal). When the body 10 enters into the range of the signal transmitted from the reader 22, the induction coil 11 inducts the signal and transmits the signal to the chip module 12 in the body 11 to activate the chip module thus to rectify and filter the signal and transmit the program or the code back to the reader via a built in antenna.

Upon receiving the signal transmitted from the body 10, the reader 22 demodulates and decodes the signal before transmitting it to a rear end host 24 of the RFID system 21 for the host 24 to judge the basic data (ID, designation, verification, etc.) of the object 13 from the program or the code.

Also referring to FIG. 3, an antenna 23 is provided to the reader of the RFID system 21 for the reader 22 to transmit RF signal. Once the body 10 enters into the signal transmission range, the body introduces the current through the antenna 23 of the reader 22 for the induction coil 11 to induct the signal.

The RFID system 21 relates to a non-contact identification technology. It automatically identifies the target through RF signal to catch data. Generally the frequency used by the reader 22 in transmitting signal is referred as the work frequency of RFID, and the radio identifiable mark works by relying upon the application of RFID technology.

As illustrated in FIGS. 1 and 2, the body 10 contains two thin plates 14 bound to each other. Both of the induction coil 11 and the chip module 12 are planted into an inner side of either of those two thin plates 14.

The induction coil 11 is printed on an inner side of either of those two thin plates 14 and the chip module 12 is installed at where between those two thin plates 14 and connected to the induction coil.

Furthermore, a CuPt film is provided on an inner side of either of those two thin plates 14 and the induction coil 11 is eroded on the CuPt film while the chip module 12 is installed at where between those two thin plates 14 and connected to the induction coil.

A logo is provided on the outer side of either of those two thin plates 14.

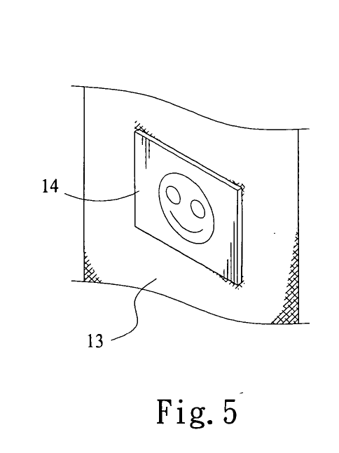

Now referring to FIGS. 4 and 5 for another preferred embodiment of the present invention, the body 10 contains a think plate 14 and a fillister is provided on the inner side and a logo is provided on the outer side of the thin plate 14. Both of the induction coil and the chip module 12 are installed in the fillister. Once the mark is attached to the object 13, the program or the code in the chip module 12 is used for distribution control and counterfeit prevention while improving the appearance of the object 13 and showing the logo.

Alternatively, both of the induction coil 11 and the chip module 12 are plated into the inner side of the thin plate 14 to achieve the same purposes of using the program or the code in the chip module 12 for distribution control and counterfeit prevention while improving the appearance of the object 13 and showing the logo.

As also illustrated in FIGS. 4 and 5, the induction coil 11 is printed on the inner side of the thin plate 14 and the chip module is installed also on that inner side to connect the induction coil 11. Once the mark is attached to the object 13, the program or the code in the chip module 12 is used for distribution control, warehousing control, resume, service records, and counterfeit prevention while improving the appearance of the object 13 and showing the logo.

A CuPt film is provided on the inner side and a logo is provided don the outer side of the thin plate 14. The induction coil 11 is eroded on the CuPt film and the chip module 12 is installed also on the inner side of the thin plate 14 and connected to the induction coil 11. Once the mark is attached to the object 13, the program or the code in the chip module 12 is used for distribution control and counterfeit prevention while improving the appearance of the object 13 and showing the logo.

The present invention by containing the program of the basic data of the object 13 installed in the chip module 12 permits the installation of more detailed information and counterfeit prevention data of the object 13 in the chip module 12. The present invention may be also applied in entrance control, card punching of attendance, and parking lot control by using the chip module 12 to transmit its data back to the rear end host 24 of the RFID system 21 through a stable RF signal source provided by the reader of the RFID system 21. The ID code of the signal transmitted from the chip module 12 to the host 24 is read for ID purpose to facilitate distribution control, identification and counterfeit prevention.

Features and advantages of the present invention are summarized as follows:
1. Advantage of the Mark: a logo is a symbolic visual language by using a pattern or letter as medium to convey the significance of a symbol of something or phenomenon. It gives concise and unique style for identification and segregation. In other words, the mark expresses or represents something in unique and specific style to not only serve a simple indication about the existence of something but also include the general representation of purpose, content and nature to impress the viewer and teach the contents of the symbol the mark represents.
2. Advantages of RFID Intellectual Tag (or the radio identifiable mark)
   a. Man-attendance is not required (not provided by bar code);
   b. Applicable in any severe environment conditions (not provided by bar code);
   c. Long range radio data ID/collection (not provided by bar code);
   d. Portable database;
   e. Real-time object/process flow traceability;
   f. Counterfeit prevention function: the chip gives read only function (not provided by bar code);
   g. Easy data identification and read-out: for the bar code system, the read out is only possible by having the scanner pointing directly at the bar code at close range and without any barrier in between. Instead, RFID TAG transmits signal as long as it is falls within the coverage of the radio;
   h. Updating data is feasible: change of bar code is not possible once printed.
   i. Repeated use: the bar code finishes its service life together with the commodity it is attached to; however, RFID TAG allows repeated use since the data contained in RFID TAG may be updated;
   j. Reading multiple lots of data at the same time: the bar coder reader reads only a single lot of data at one time; on the other hand, RFID TAG identifier may read multiple RFID TAGs at the same time;
   k. Security: RFID TAG is read and write encrypted to prevent easy counterfeit and forge.
   l. Large data storage capacity: ID bar code has the storage capacity of 50 Bytes; 2D, 2˜3000 characters; and RFID TAG, several Megabytes at its maximum; and
   m. Physical contact is not required in radio transmission, and specific orientation is also not required during data exchange.
3. Advantages of radio identifiable mark: it incorporates advantages of mark and RFID radio intellectual tag.
   a. Furthermore, additional functions can be provided as follows:
      i. A single radio identifiable mark provides the functions of the mark and the RFID Tag;
      ii. Date of resume, physical characteristics and service record of the object attached with the radio identifiable mark can be written in.
      iii. Manufacturer of the object may effectively track down any information about the object from the chip installed in the radio identifiable mark.
      iv. Improve the object control efficiency.
4. Applications of the Radio Identifiable Mark:
   Distribution control: supply chain, distribution and inventory control
   Entrance Control: office building entrance control
   Package Mail Control: luggage ID in air transportation, handling of mails and packages
   Library control: libraries control, file and document tracing
   Assembly and Manufacturing: materials control of production, manufacturing, assembly, and service records
   Disposal of Refuses: garbage treatment
   Medical application: control of medical equipment and resume of patients
   Communications and transportation: free way tolling system and tickets
   Burglar proof and counterfeit prevention: burglarproof system and bill counterfeit protection in supermarket.
   Animal monitor: animal chip, and wild animal ecology tracing.
   Identification.
      The radio identifiable mark of the present invention is innovative. It has never been disclosed in any publication and not seen any similar product generally available in the market. It gives the unique characteristics and functions that cannot be matched by the prior art. Therefore, this application for a utility patent is filed accordingly.

However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention

1. A radio identifiable mark includes an induction coil, a chip module electrically connected to the induction coil and burnt in a program or code for identification; and a thin plate having on its surface provided with a logo and both of the induction coil and the chip module being planted in the inner side of the thin plate; the mark being attached onto an object; the mark entering into a range of radio signal transmitted from a RAID reader and having its induction coil to induct the signal and transmit it to the chip module of the mark; and the signal being rectified and filtered by the chip module to provide energy to activate the chip module for transmitting the burnt in program (or code) back to the reader through a built-in antenna to create radio induction transmission and receiving mechanism for further process.

2. The radio identifiable mark of claim 1, wherein the induction coil is printed on the surface on the inner side of the thin plate and the chip module is installed on the inner side of the thin plate and connected to the induction coil.

3. The radio identifiable mark of claim 1, wherein a CuPt film is provided on the inner side of the thin plate; the induction coil is eroded on the CuPt film; and the chip module is installed on the inner side of the thin plate and connected to the induction coil.

4. The radio identifiable mark of claim 1, wherein a fillister is provided on the inner side of the thin plate to accommodate the installation of the induction coil and the chip module.

5. A radio identifiable mark of claim 1 includes an induction coil, a chip module electrically connected to the induction coil and burnt in a program or code for identification; and a two thin plates bound to each other with one having on its outer side provided with a logo and both of the induction coil and the chip module being planted into an inner side of either thin plate; he mark being attached onto an object; the mark entering into a range of radio signal transmitted from a RAID reader and having its induction coil to induct the signal and transmit it to the chip module of the mark; and the signal being rectified and filtered by the chip module to provide energy to activate the chip module for transmitting the burnt in program (or code) back to the reader through a built-in antenna to create radio induction transmission and receiving mechanism for further process.

6. The radio identifiable mark of claim 1, wherein the induction coil is printed on an inner side of either of those two thin plates, and the chip module is installed at where between both thin plates and connected to the induction coil.

7. The radio identifiable mark of claim 1, wherein a CuPt film is provided on an inner side of either of those two thin plates, and the chip module is installed at where between both thin plates and connected to the induction coil.
